(19) United States
(12) Patent Application Publication
(10) Pub. No.: US 2023/0042576 A1
(43) Pub. Date: Feb. 9, 2023

(54) ELECTRIC SPARKLING WATER MACHINE AND USE METHOD THEREOF

(71) Applicant: Zhejiang Hongfeng Precision Co.,Ltd, YONGKANG (CN)

(72) Inventors: Ping Wang, YONGKANG (CN); Xiaohua Wu, YONGKANG (CN)

(73) Assignee: Zhejiang Hongfeng Precision Co.,Ltd, YONGKANG (CN)

(21) Appl. No.: 17/973,573

(22) Filed: Oct. 26, 2022

(30) Foreign Application Priority Data
Sep. 17, 2022 (CN) 202211133301.2

(51) Int. Cl. B01F 23/2361; A47J 31/44

(52) U.S. Cl. CPC B01F 23/23611; A47J 31/4403

(57) ABSTRACT

The present invention discloses an electric sparkling water machine, comprising a machine body, and a water bottle and a gas bottle which are installed on the machine body, wherein the machine body is provided with a control switch and a control board, and the control switch provides a plurality of control gears; the machine body is provided with a movable pressure rod for driving an intake thimble to downward control the gas bottle to inflate the water bottle; the electric sparkling water machine further comprises: a motor connected with the pressure rod through a transmission mechanism for controlling the pressure rod to move; a detection switch for providing signals for the control board; a pressure sensor communicated with an exhaust port of the water bottle for triggering the detection switch; and an exhaust valve connected with the exhaust port of the water bottle.

### TECHNICAL FIELD

The present invention relates to the technical field of electric sparkling water machines, and particularly to an electric sparkling water machine and a use method thereof.

### BACKGROUND

A sparkling water machine is a machine for making sparkling water. Carbon dioxide is instantaneously injected into a water bottle through a gas bottle containing compressed carbon dioxide, so that the gas reaches a certain solubility value in liquid such as water or fruit juice.

At present, on most sparkling water machines, in the use process, the dissolved concentration value of the carbon dioxide in the water bottle is fixed. Aerated water made by dissolving different amounts of carbon dioxide in water tastes different. To satisfy the needs of different groups of users, it is necessary to make a sparkling water machine capable of regulating the concentration of the carbon dioxide in the water bottle.

Thus, the inventor proposes a patent with publication number CN113303668A, and discloses a sparkling water machine capable of controlling carbon dioxide solubility, to realize electric control of solubility in the water bottle and achieve the technical effects of operation convenience and control accuracy. However, the control mode of the electric sparkling water machine with this structure is relatively simple (only set solubility value requirements can be controlled), and a plurality of gear switches are needed to match a plurality of corresponding different gears, thereby complicating the internal structure and increasing the difficulty of assembly and production cost.

### SUMMARY

To solve the technical problems, the present invention adopts the following technical solution: an electric sparkling water machine comprises a machine body, and a water bottle and a gas bottle which are installed on the machine body, wherein the machine body is provided with a control switch and a control board, and the control switch provides a plurality of control gears; the machine body is provided with a movable pressure rod for driving an intake thimble to downward control the gas bottle to inflate the water bottle; the electric sparkling water machine further comprises: a motor connected with the pressure rod through a transmission mechanism for controlling the pressure rod to move; a detection switch for providing signals for the control board; a pressure sensor communicated with an exhaust port of the water bottle for triggering the detection switch; an exhaust valve connected with the exhaust port of the water bottle for achieving exhaust control through the action of the transmission mechanism of the motor or the pressure rod; the exhaust valve also has the effect of a safety valve; and when the detection switch fails, the air pressure in the water bottle continues to increase to reach the set pressure of the exhaust valve and inflate and exhaust automatically.

When a first gear of the control switch is executed, the motor drives the pressure rod to downward control the gas bottle to inflate the water bottle; when the pressure of the water bottle reaches a set value, the pressure sensor triggers the detection switch, and the control board controls the motor and the transmission mechanism to return to stop inflating the water bottle and then drive the exhaust valve to exhaust the gas in the water bottle;

When other gears of the control switch are executed, the control board controls the delay return of the motor or controls the motor to perform two or more repetitive actions to realize the control of inflating time or inflating times of the gas bottle.

In the above technical solution, further, the pressure rod has three staying gears in the return process of the motor and the transmission mechanism: when the end of the pressure rod is at the bottom, the gas bottle is inflated but the exhaust valve does not work; when the end of the pressure rod is lifted to a middle position, the gas bottle is not inflated and the exhaust valve does not work; when the end of the pressure rod is lifted to a high position, the gas bottle is not inflated and the exhaust valve works.

In the above technical solution, further, the control board controls the motor to drive the transmission mechanism to perform different actions, and then controls the pressing degree, pressing frequency and pressing time of the pressure rod, to achieve the control of an intake state in the water bottle.

In the above technical solution, further, the pressure sensor comprises: a cavity; the cavity provides an inlet end; the inlet end is communicated with the exhaust port of the water bottle through a conduit; a movable piston push rod and a limiting sleeve are arranged in the cavity; the piston push rod extends from the cavity and is kept close to the detection switch; a spring is arranged between the piston push rod and the limiting sleeve; and during work, gas in the water bottle enters from the inlet end and pushes the piston push rod to overcome the acting force of the spring to gradually move toward the detection switch until the detection switch is started.

In the above technical solution, further, when the detection switch is started, the control board controls the motor to return immediately or return in delay, to drive the transmission mechanism to self-return.

In the above technical solution, further, when the detection switch is started, the control board controls the motor to return immediately, or return for a period of time to work again for repeated times; and after the motor returns, the transmission mechanism is driven to self-return.

In the above technical solution, further, an elastic element is also arranged, and the elastic element is used for driving the pressure rod to realize self-return when not driven by the motor and the transmission mechanism.

In the above technical solution, further, the transmission mechanism comprises a cam handle; a first end of the cam handle is connected with a motor shaft of the motor, and a second end is provided with a dial rod; the dial rod is arranged in a chute at the end of the pressure rod; when the cam handle rotates downward, the pressure rod is driven to press; when the motor is deenergized, the cam handle is returned upward under the drive of self-return of the motor or an external force; and when the cam handle reaches the top, the first end of the cam handle presses an exhaust ejector rod of the exhaust valve, to make the exhaust valve work.

Further, a use method of an electric sparkling water machine is provided, which uses the above electric sparkling water machine. The electric sparkling water machine provides a first control mode: according to different solubility values required in the water bottle, the control gears specifically comprise a low gear, a middle gear and a high gear;

At the low gear, the motor rotates to drive the pressure rod to a lowest position to inflate; when pressure in the water bottle reaches a set value, the pressure sensor triggers the detection switch; a signal is transmitted to the control board, and then the motor is controlled so that the motor is returned after a first time interval under the action of external force or self-return force of the motor; the pressure rod is automatically lifted to a highest position; at the same time of returning, the motor also drives the transmission mechanism to make the exhaust valve work; and the solubility value in the water bottle achieves the setting demand of the low gear;

When the middle gear is executed, the motor rotates to drive the pressure rod to the lowest position to inflate; when the pressure in the water bottle reaches a set value, the pressure sensor triggers the detection switch; the signal is transmitted to the control board, and then the motor is controlled to return after a second time interval; the second time interval is greater than the first time interval, so that the return time of the motor is subjected to delay control; in this process, the exhaust valve also works;

When the high gear is executed, the motor is returned after a third time interval; and the third time interval is greater than the second time interval.

Further, a use method of an electric sparkling water machine is provided, which uses the above electric sparkling water machine. The electric sparkling water machine provides a second control mode: according to different solubility values required in the water bottle, the control gears specifically comprise a low gear, a middle gear and a high gear;

At the low gear, the motor rotates to drive the pressure rod to a lowest position to inflate; when pressure in the water bottle reaches a set value, the pressure sensor triggers the detection switch; a signal is transmitted to the control board, and then the motor is controlled so that the motor is returned after a first time interval under the action of external force or self-return force of the motor; the pressure rod is automatically lifted to a highest position; at the same time of returning, the motor also drives the transmission mechanism to make the exhaust valve work; and the solubility value in the water bottle achieves the setting demand of the low gear;

When the middle gear is executed, the motor rotates to drive the pressure rod to the lowest position to inflate; when the pressure in the water bottle reaches a set value, the pressure sensor triggers the detection switch; the signal is transmitted to the control board, and the motor works again after returning for a period of time to drive the pressure rod to realize inflating and returning again; the process of repeated inflating is executed twice or more times; and after the repeated process is completed, the exhaust valve works, so that concentration and the solubility value achieve the setting demand of the middle gear;

When the high gear is executed, the motor is returned to work for more times than the middle gear, so that the concentration and the solubility value achieve the setting demand of the high gear.

The patent of the present invention has the beneficial effects that: compared with the prior art, only one group of control mechanism and execution mechanism is arranged, which can realize intake control in multiple modes; and according to different execution modes, the present invention can be applicable to different use requirements, thereby greatly simplifying the internal structure and improving the use functionality.

### DESCRIPTION OF DRAWINGS

The present invention will be further described below in combination with the drawings and the embodiments.

FIG. 1 is an external structural schematic diagram of the present invention.

FIG. 2 is a structural schematic diagram 1 of a hidden part shell of the present invention.

FIG. 3 is a structural schematic diagram 2 of a hidden part shell of the present invention.

FIG. 4 is a structural schematic diagram of an exhaust valve of the present invention.

FIG. 5 is a structural schematic diagram of a pressure sensor of the present invention.

FIG. 6 is an internal schematic diagram of a pressure sensor of the present invention.

FIG. 7 is a structural form 2 of a transmission structure of the present invention.

FIG. 8 is a structural form 2 of a transmission structure of the present invention.

FIG. 9 is a structural form 3 of a transmission structure of the present invention.

In the figures, 1. machine body; 2. water bottle; 3. gas bottle; 31. exhaust port; 4. control panel; 41. control gear; 411. low gear; 412. middle gear; 413. high gear; 5. control board; 6. motor; 7. pressure rod; 71. chute; 8. transmission mechanism; 81. cam handle; 82. dial rod; 83. rotating handle; 84. pull rod; 85. cam block; 9. intake thimble; 10. pressure sensor; 101. cavity; 102. inlet end; 103. movable hole; 104. piston push rod; 105. limiting sleeve; 106. spring; 11. detection switch; 12. exhaust valve; 121. air inlet passage; 122. exhaust ejector rod; 13. elastic element.

### DETAILED DESCRIPTION

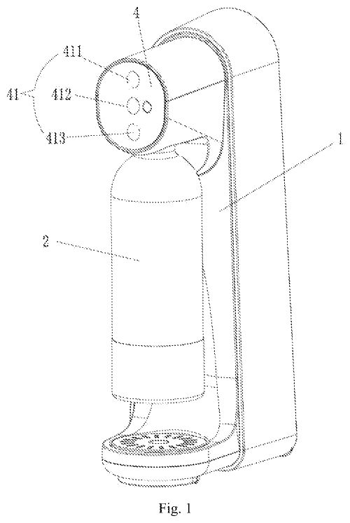

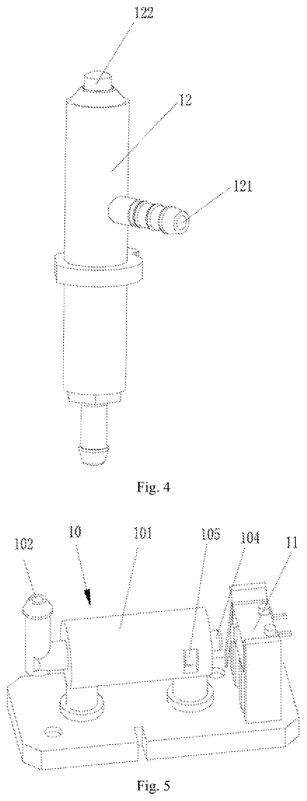

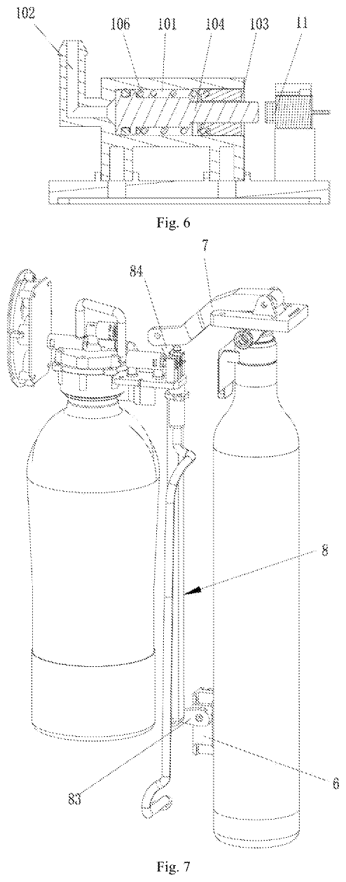

As shown in FIGS. 1-9, the present embodiment shows an electric sparkling water machine, comprising a machine body 1, and a water bottle 2 and a gas bottle 3 which are detachably installed on the machine body 1. The machine body 1 is provided with a control panel 4 and a control board 5, and the control board is preferably a PCBA. The control panel 4 is provided with a control switch presented outside the sparkling water machine. The control switch provides a plurality of control gears 41 which are specifically a low gear 411, a middle gear 412, a high gear 413 and an unlocking switch in the present embodiment.

A motor 6 is installed in the machine body 1, and the motor 6 is electrically connected with the control board 5 and is controlled by the control switch 4 to perform actions.

A pressure rod 7 is arranged above the gas bottle 3. One end of the pressure rod 7 is rotatably arranged on the machine body 1, and the other end is connected with the motor 6 through a transmission mechanism 8. The motor 6 rotates and then drives the pressure rod 7 to press down, and drives the intake thimble 9 down to complete the gas discharge of the gas bottle 3, so that the gas enters the water bottle 2 through the conduit and is released and dissolved. This process is called inflating. In the present embodiment, the transmission mechanism 8 is driven to perform different actions through the rotation angle of a motor 6 shaft of the motor 6, to control the pressing degree, pressing frequency and pressing time of the pressure rod 7, so as to finally achieve the control of an inflating state.

The rotation of the motor 6 is controlled by a pressure sensor 10 arranged in the machine body 1 and a detection switch 11. The pressure sensor 10 can be mechanical or electronic, and the detection switch 11 can be a micro switch or a proximity switch. In the present embodiment, a mechanical pressure sensor 10 is matched with the micro switch. Specifically, the pressure sensor 10 is communicated with an exhaust port 31 of the water bottle 2 through a conduit. The exhaust port 31 is arranged on a base of the water bottle, communicated with the interior of the water bottle, and used to perform exhaust work of the gas inside the water bottle. For the specific form of the exhaust port 31, there is no specific limitation in the present application. When the water bottle 2 is inflated and when the pressure in the bottle reaches a certain value, the air pressure in the bottle will be transmitted into the pressure sensor 10 through the exhaust port 31, and then a piston in the pressure sensor 10 is pushed to move until contact with the micro switch. The micro switch transmits a signal to the control board 5 through a circuit to control power failure or self-return of the motor 6. The motor after self-return or the motor which is returned under an external force after power failure stops inflating the water bottle 2 by the gas bottle 3. Supplementary illustration is provided at this moment. The working mode of the motor 6 is: during work, in a process that the motor rotates and drives the pressure rod 7 to work through the transmission mechanism until the control board 5 controls the motor to return, the motor works with electricity; and in this process, the motor conducts self-return. Another mode is that the control board 5 is used to control the on and off of a motor circuit. When the power is off, the motor is returned by the external force (such as a torsion spring and a tension spring), and the on and off of the circuit are used to achieve work or return. It is further explained that the return of this type of motor (a steering engine and a servo motor) is completed by electric pulse, and when the power failure of the motor is caused by the fault of the control board, the motor is returned by external force including an intake valve on the gas bottle.

The pressure sensor 10 specifically comprises a cavity 101. The cavity 101 provides an inlet end 102 and a movable hole 103. The inlet end 102 is communicated with the exhaust port 31 of the water bottle 2 through a conduit. A movable piston push rod 104 and a limiting sleeve 105 are arranged in the cavity 101. The piston push rod 104 extends from the movable hole 103, and is kept close to the micro switch. A spring 106 is arranged between the piston push rod 104 and the limiting sleeve 105. During work, the gas in the water bottle 2 enters from the inlet end 102 and pushes the piston push rod to overcome the acting force of the spring 106 to gradually move to the micro switch, until contact with the micro switch.

An exhaust valve 12 is also arranged in the machine body 1. An inlet of the exhaust valve 12 is connected with the exhaust port 31 of the water bottle 2 through a conduit, and an outlet of the exhaust valve 12 extends to a lower part of the machine body 1 through a conduit. The specific structure and working principle of the exhaust valve 12 can refer to patent CN215334705U proposed by the inventor, and will not be specifically repeated here. In the present embodiment, an air inlet passage 121 of the exhaust valve 12 is used to connect the water bottle 2, and an exhaust ejector rod 122 is driven by the transmission mechanism 8 or the pressure rod 7. The arrangement position of the exhaust valve 12 can be arbitrary, and only needs to ensure that the exhaust ejector rod 122 will move down to exhaust when the pressure rod 7 completes the intake and is lifted. In the present embodiment, when the pressure rod 7 is at the bottom, the sparkling water machine is inflated but not exhausted; and after the control board controls the motor and the pressure rod to return, the sparkling water machine is not inflated but is exhausted through the exhaust valve 12.

As a further embodiment, the pressure rod 7 has three staying gears. When the pressure rod 7 is at the bottom, the sparkling water machine is inflated but not exhausted; when the pressure rod is lifted to the second gear (a relatively middle position), the sparkling water machine is not inflated and exhausted; and when the pressure rod is lifted to the third gear (a relatively high position), the sparkling water machine is not inflated but exhausted through the exhaust valve 12.

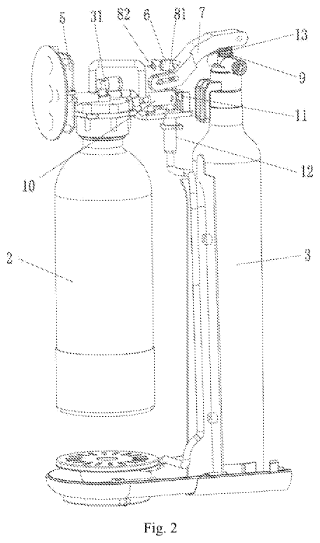

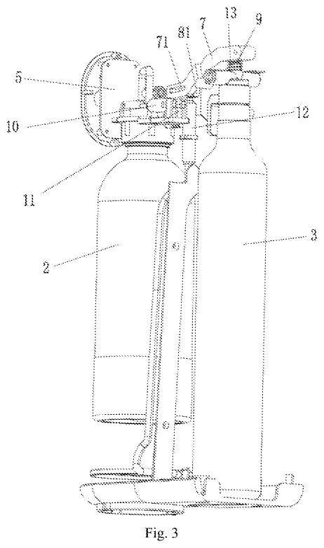

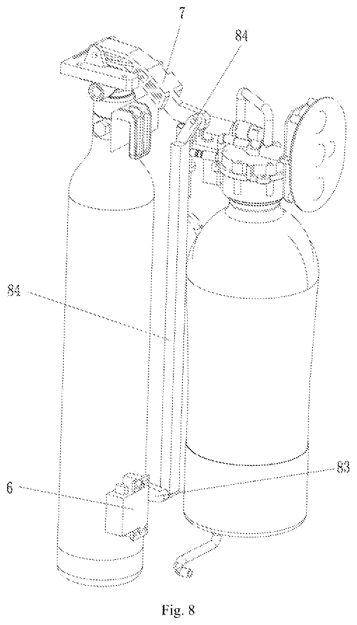

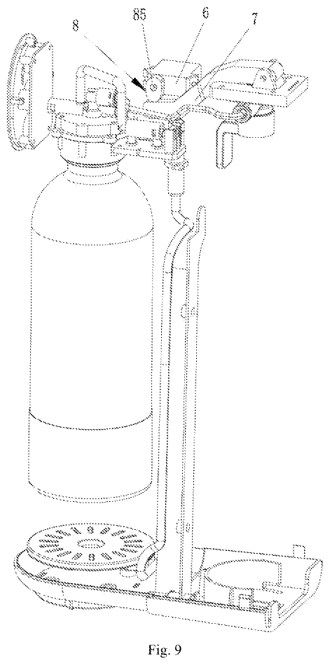

In the present application, the transmission mechanism 8 used to drive the rotation of the pressure rod 7 can be in multiple forms, to achieve the arrangement of the sparkling water machines with different structures. In the present embodiment, there are mainly the following three arrangement forms: FIGS. 2-3 show the first arrangement form of the transmission mechanism 8; the motor 6 is arranged at the upper part of the machine body 1; the transmission mechanism 8 comprises a cam handle 81; a first end of the cam handle 81 is connected with a motor 6 shaft of the motor 6, and a second end is provided with a dial rod 82; the dial rod 82 is arranged in a chute 71 at the end of the pressure rod 7; when the cam handle 81 rotates downward, the pressure rod 7 is driven to press; when the motor 6 is returned, the cam handle 81 is returned upward respectively under the drive of self-return of the motor 6 or an external force; and when the cam handle reaches the top, the first end of the cam handle 81 presses the exhaust ejector rod 122 of the exhaust valve 12, to make the exhaust valve 12 work. FIGS. 7-8 show the second arrangement form of the transmission mechanism 8; the motor 6 is arranged at the lower part of the machine body 1; the transmission mechanism 8 comprises a rotating handle 83 and a pull rod 84; the rotating handle 83 is connected with the motor 6 shaft; the pull rod 84 extends up and down; the lower end of the pull rod is hinged with the rotating handle 83, and the upper end is hinged with the pressure rod 7; and the pull rod 84 is driven up and down through the rotation of the motor 6 to control the pressing condition of the pressure rod 7. FIG. 9 shows the third arrangement form of the transmission mechanism 8; the rotating mechanism is a cam block 85 rotatably connected with the motor 6 shaft; and the cam block 85 and the upper end of the pressure rod 7 maintain contact to control the pressing condition of the pressure rod 7.

To enable the pressure rod 7 to self-return, an elastic element 13 is arranged for driving the pressure rod 7. The elastic element 13 can be a tension spring arranged above the pressure rod 7 or a spring 106 arranged below the pressure rod 7 in any arrangement form and position as long as the pressure rod 7 is ensured to return upward without the control of the motor 6. In the present embodiment, the spring 106 sleeved outside the intake thimble 9 at a mouth of the gas bottle 3 is preferred.

According to different solubility values (inflating amount in the water bottle 2), there are a low gear 411, a middle gear 412 and a high gear 413 in the present embodiment. At the low gear 411, the motor 6 rotates to drive the pressure rod 7 to a lowest position to inflate; when pressure in the water bottle 2 reaches a set value, the pressure sensor 10 conducts the micro switch; a signal is transmitted to the control board 5, and then the motor 6 is controlled so that the motor is returned after a first time interval under the action of external force or self-return force of the motor; under the action of the spring 106 and the return of the motor 6, when the pressure rod 7 is automatically lifted to a highest position, the motor 6 also drives the transmission mechanism 8 to make the exhaust valve 12 work; and the solubility value in the water bottle 2 achieves the setting demand of the low gear 411.

When the middle gear 412 is executed, the motor 6 rotates to drive the pressure rod 7 to the lowest position to inflate; when the pressure in the water bottle 2 reaches a set value, the pressure sensor 10 conducts the micro switch; the signal is transmitted to the control board 5, and then the motor 6 is controlled to return after a second time interval (the motor is powered off and returned under the external force or the motor is self-returned); the second time interval is greater than the first time interval, e.g., 2-3 seconds, so that the return time of the motor 6 is subjected to delay control; then, the inflating time is prolonged and the concentration and the dissolution are more adequate to achieve the setting demand of the middle gear 412. In this process, the exhaust valve 12 also works.

When the high gear 413 is executed, the motor 6 is returned after a third time interval; and the third time interval is greater than the second time interval. Compared with the middle gear 412, the inflating time is further increased so that the concentration and solubility value achieve the setting demand of the high gear 413.

The above is the first mode of solubility value control, and the inflating time is mainly controlled by means of the return time of the motor 6.

For the control of the second mode: at the low gear 411, the motor 6 rotates to drive the pressure rod 7 to a lowest position to inflate; when pressure in the water bottle 2 reaches a set value, the pressure sensor 10 conducts the micro switch; a signal is transmitted to the control board 5, and then the motor 6 is controlled so that the motor is returned after a first time interval (the motor is powered off and returned under the external force or the motor is self-returned); under the action of the spring 106 and the return of the motor 6, when the pressure rod 7 is automatically lifted to a highest position, the motor 6 also drives the transmission mechanism 8 to make the exhaust valve 12 work; and the solubility value in the water bottle 2 achieves the setting demand of the low gear 411.

When the middle gear 412 is executed, the motor 6 rotates to drive the pressure rod 7 to the lowest position to inflate; when the pressure in the water bottle 2 reaches a set value, the pressure sensor 10 conducts the micro switch; the signal is transmitted to the control board 5, and the motor 6 works again after returning for a period of time to drive the pressure rod 7 to realize inflating and returning again; the process of repeated inflating is executed for N times, e.g., 2-3 times (which is the process of making the motor 6 execute return-work and return-work); and after the repeated process is completed, the exhaust valve 12 works, so that concentration and the solubility value achieve the setting demand of the middle gear 412.

When the high gear 413 is executed, the motor 6 is returned for more times than the middle gear 412, so that the concentration and the solubility value achieve the setting demand of the high gear 413.

For the second mode, the most prominent beneficial effect is: in the process from the completion of the first inflating to the repeated second inflating, due to the existence of a certain time of non-inflating state, the solution in the water bottle 2 can fully dissolve carbon dioxide gas in this time course. If inflating is continuous, not intermittent proposed in this mode, the solution in the water bottle 2 may have many bubbles, so that liquid is easy to spray upward and easy to enter an exhaust pipe, thereby influencing the use.

The above only describes preferred embodiments of the present invention, not intended to limit the present invention in any form. Simple amendments, equivalent changes or modifications made on the basis of not deviating from the technical solution of the present invention fall into the protection scope of the present invention.

1. An electric sparkling water machine, comprising a machine body, and a water bottle and a gas bottle which are installed on the machine body, wherein the machine body is provided with a control switch and a control board, and the control switch provides a plurality of control gears; the machine body is provided with a movable pressure rod for driving an intake thimble to downward control the gas bottle to inflate the water bottle, wherein the electric sparkling water machine further comprises:
a motor connected with the pressure rod through a transmission mechanism for controlling the pressure rod to move;
a detection switch for providing signals for the control board;
a pressure sensor communicated with an exhaust port of the water bottle for triggering the detection switch;
an exhaust valve connected with the exhaust port of the water bottle for achieving exhaust control through the action of the transmission mechanism of the motor or the pressure rod;
when a first gear of the control switch is executed, the motor drives the pressure rod to downward control the gas bottle to inflate the water bottle; when the pressure of the water bottle reaches a set value, the pressure sensor triggers the detection switch, and the control board controls the motor and the transmission mechanism to return to stop inflating the water bottle and then drive the exhaust valve to exhaust the gas in the water bottle;
when other gears of the control switch are executed, the control board controls the delay return of the motor or controls the motor to perform two or more repetitive actions to realize the control of inflating time or inflating times of the gas bottle.

2. The electric sparkling water machine according to claim 1, wherein the pressure rod has three staying gears in the return process of the motor and the transmission mechanism: when the end of the pressure rod is at the bottom, the gas bottle is inflated but the exhaust valve does not work; when the end of the pressure rod is lifted to a middle position, the gas bottle is not inflated and the exhaust valve does not work; when the end of the pressure rod is lifted to a high position, the gas bottle is not inflated and the exhaust valve works.

3. The electric sparkling water machine according to claim 1, wherein the control board controls the motor to drive the transmission mechanism to perform different actions, and then controls the pressing degree, pressing frequency and pressing time of the pressure rod, to achieve the control of an intake state in the water bottle.

4. The electric sparkling water machine according to claim 1, wherein the pressure sensor comprises: a cavity; the cavity provides an inlet end; the inlet end is communicated with the exhaust port of the water bottle through a conduit; a movable piston push rod and a limiting sleeve are arranged in the cavity; the piston push rod extends from the cavity and is kept close to the detection switch; a spring is arranged between the piston push rod and the limiting sleeve; and during work, gas in the water bottle enters from the inlet end and pushes the piston push rod to overcome the acting force of the spring to gradually move toward the detection switch until the detection switch is started.

5. The electric sparkling water machine according to claim 1, wherein when the detection switch is started, the control board controls the motor to return immediately or return in delay, to drive the transmission mechanism to self-return.

6. The electric sparkling water machine according to claim 1, wherein when the detection switch is started, the control board controls the motor to return immediately, or return for a period of time to work again for repeated times; and after the motor returns, the transmission mechanism is driven to self-return.

7. The electric sparkling water machine according to claim 1, wherein an elastic element is also arranged, and the elastic element is used for driving the pressure rod to realize self-return when not driven by the motor and the transmission mechanism.

8. The electric sparkling water machine according to claim 1, wherein the transmission mechanism comprises a cam handle; a first end of the cam handle is connected with a motor shaft of the motor, and a second end is provided with a dial rod; the dial rod is arranged in a chute at the end of the pressure rod; when the cam handle rotates downward, the pressure rod is driven to press; when the motor is deenergized, the cam handle is returned upward under the drive of self-return of the motor or an external force; and when the cam handle reaches the top, the first end of the cam handle presses an exhaust ejector rod of the exhaust valve, to make the exhaust valve work.

9. A use method of an electric sparkling water machine, using the electric sparkling water machine of claim 1, wherein the electric sparkling water machine provides a first control mode:
according to different solubility values required in the water bottle, the control gears specifically comprise a low gear, a middle gear and a high gear;
at the low gear, the motor rotates to drive the pressure rod to a lowest position to inflate; when pressure in the water bottle reaches a set value, the pressure sensor triggers the detection switch; a signal is transmitted to the control board, and then the motor is controlled so that the motor is returned after a first time interval under the action of external force or self-return force of the motor; the pressure rod is automatically lifted to a highest position; at the same time of returning, the motor also drives the transmission mechanism to make the exhaust valve work; and the solubility value in the water bottle achieves the setting demand of the low gear;
when the middle gear is executed, the motor rotates to drive the pressure rod to the lowest position to inflate; when the pressure in the water bottle reaches a set value, the pressure sensor triggers the detection switch; the signal is transmitted to the control board, and then the motor is controlled to return after a second time interval; the second time interval is greater than the first time interval, so that the return time of the motor is subjected to delay control; in this process, the exhaust valve also works;
when the high gear is executed, the motor is returned after a third time interval; and the third time interval is greater than the second time interval.

10. A use method of an electric sparkling water machine, using the electric sparkling water machine of claim 1, wherein the electric sparkling water machine provides a second control mode: according to different solubility values required in the water bottle, the control gears specifically comprise a low gear, a middle gear and a high gear;
at the low gear, the motor rotates to drive the pressure rod to a lowest position to inflate; when pressure in the water bottle reaches a set value, the pressure sensor triggers the detection switch; a signal is transmitted to the control board, and then the motor is controlled so that the motor is returned after a first time interval under the action of external force or self-return force of the motor; the pressure rod is automatically lifted to a highest position; at the same time of returning, the motor also drives the transmission mechanism to make the exhaust valve work; and the solubility value in the water bottle achieves the setting demand of the low gear;
when the middle gear is executed, the motor rotates to drive the pressure rod to the lowest position to inflate; when the pressure in the water bottle reaches a set value, the pressure sensor triggers the detection switch; the signal is transmitted to the control board, and the motor works again after returning for a period of time to drive the pressure rod to realize inflating and returning again; the process of repeated inflating is executed twice or more times; and after the repeated process is completed, the exhaust valve works, so that concentration and the solubility value achieve the setting demand of the middle gear;
when the high gear is executed, the motor is returned to work for more times than the middle gear, so that the concentration and the solubility value achieve the setting demand of the high gear.
